(19) United States
(12) Patent Application Publication
(10) Pub. No.: US 2008/0251273 A1
(43) Pub. Date: Oct. 16, 2008

(54) Plenum Cable Flame Retardant Layer/Component with Excellent Aging Properties

(76) Inventors: Geoffrey D. Brown, Bridgewater, NJ (US); Jeffrey M. Cogen, Flemington, NJ (US); Jinder Jow, Singapore (SG); Kurt A. Bolz, Allentown, NJ (US)

Correspondence Address: The Dow Chemical Company, Intellectual Property Section, P.O. Box 1967, Midland, MI, 48641-1967, US

(21) Appl. No.: 11/817,326

(22) PCT Filed: Mar. 3, 2006
(86) PCT No.: PCT/US06/07781

§ 371 Date: Aug. 29, 2007

Related U.S. Application Data
(60) Provisional application No. 60/658,410, filed on Mar. 3, 2005.

(51) Int. Cl. H01B 7/295; H01B 11/04; C08K 3/34; C08K 3/32; C08K 3/22

(52) U.S. Cl. 174/113 R; 524/414; 524/430; 524/445

(57) ABSTRACT

The present invention is a plenum cable component with excellent fire retardant and aging properties. The plenum cable component is prepared from a polyolefin-based composition, containing an olefinic polymer and a surface treated metal hydroxide. Depending upon the surface treatment, the composition may comprise other components. The present invention is also a method for selecting a composition for preparing the plenum cable component as a separator and a method for preparing a communications cable therefrom.

This invention relates to a plenum cable designed to achieve the requirements of National Fire Protection Association 262: Standard Method of Test for Flame Travel and Smoke of Wires and Cables for Use in Air-Handling Spaces, 2002 Edition (“NFPA-262”) and exhibit excellent aging properties. In particular, the present invention relates to polyolefin-based compositions useful in preparing flame retardant layers/components with excellent aging, electrical properties.

### DESCRIPTION OF THE PRIOR ART

Plenum cables exhibit a high level of flame retardant performance. They were developed for use in enclosed spaces where excessive smoke or fire spread would pose a significant hazard, such as plenum air space above suspended ceilings in office buildings. For example, when the plenum cable is a “twisted-pair” type communication cable, its flame retardant performance depends upon the entire cable design and especially upon the materials selected for the jacket, the twisted pairs of insulated conductors, and any core tapes or separator components.

In building designs, plenum cables must resist the spread of flame and the generation of and spread of smoke throughout a building in case of an outbreak of fire. Cables intended for installations in the air handling spaces of buildings are specifically required to pass the flame test specified by Underwriters Laboratories Inc. (UL), UL-910, or its Canadian Standards Association (CSA) equivalent, the FT6. The UL-910 and the FT6 represent the top of the fire rating hierarchy established by the NEC and CEC respectively. UL-910 is equivalent to NFPA-262.

Conventional designs of data grade telecommunication cable for installations in plenum chambers have a jacket material that provides for low smoke and flame spread. Examples of jacket materials include filled PVC formulations and a fluoropolymer materials.

The jacket surrounds a core of twisted conductor pairs with each conductor individually insulated with a material having a low dielectric constant and a low dissipation factor. (The low dielectric constant and low dissipation factor are desirable for good high frequency signal “data grade” transmission.) Perfluoro ethylene-propylene copolymer (FEP) material is widely used as insulating material because it combines good material electrical performance with good material burn characteristics.

However, FEP is a high cost material. Accordingly, there has been extensive interest in identifying lower cost alternatives with overall acceptable performance.

Flame retardant polyolefin compositions incorporating halogen flame retardant additive systems already see limited use in plenum insulation applications. The halogen flame retardant polyolefin are sometimes used as single layer insulation or a component in a multilayer design with FEP to insulate some (with FEP insulated wire in mixed pair designs) or all of the conductors. Despite lower materials cost as compared to FEP and good humid aged electrical properties, the use of halogen flame retardant polyolefin compositions in plenum cables has been greatly limited by marginal performance in plenum cable burn tests. In particular, these halogen flame retardant polyolefin compositions do not provide a desirable combination of low flame spread and low smoke generation characteristics when incorporated into plenum cables, leading to UL-910 cable burn test failure.

The core can also include a tape or extruded profile separator that provides spacing between the conductor pairs to provide enhanced signal transmission performance. The electrical requirements for these tape or separator components are similar to those applicable to the insulation application—good dielectric constant and dissipation factor electrical characteristics. These materials must also contribute to good cable burn characteristics with low smoke and flame spread. FEP has been the incumbent material in separator applications.

U.S. Pat. No. 6,639,152 contends that solid flame retardant/smoke suppressed polyolefins may be used in connection with fluorinated polymers, but the '152 patent notes that commercially available solid flame retardant/smoke suppressed polyolefin compounds exhibit inferior resistance to burning and generally produce more smoke than FEP under burning conditions. Similarly, U.S. Pat. Nos. 5,789,711 and 6,222,130 and published patent application No. US2001/0001426 postulate that copolymers may be used for making the separator to achieve the desired properties, but none discloses potential copolymers or how to select those copolymers.

Additionally, U.S. Pat. No. 5,969,295 and European Patent Application No. EP 1 162 632 indicate that suitable materials for the separator are polyvinylchloride, polyvinylchloride alloys, polyethylene, polypropylene, and flame retardant materials such as fluorinated polymers, yet, like the previously mentioned disclosures, they fail to teach which polyolefinic materials would yield the desired flame retardant and smoke control properties.

U.S. Pat. No. 6,150,612 indicates that it is not desirable for the separator to have a dielectric constant greater than 3.5 in the frequency range from 1.0 MHz to 400 MHz and describes a separator comprising flame retardant polyethylene (FRPE) having a dielectric constant of 2.5 and a loss factor of 0.001. Additionally, the '612 patent discloses that polyfluoroalkoxy (PFA), TFE/Perfluoromethylvinylether (MFA), ethylene chlorotrifluoroethylene (CTFE), polyvinyl chloride (PVC), FEP, and flame retardant polypropylene (FRPP) may be suitable materials for achieving the electrical properties of the separator.

While highlighting appropriate electrical properties for the separator, the '612 patent does not describe the appropriate flame retardant or smoke control properties of the separator or teach which, if any, polyolefinic materials can achieve the desired flame retardant properties. Instead, the '612 patent focuses on ensuring that the jacket achieve the desired electrical properties.

Interestingly, U.S. Pat. No. 6,074,503 recognizes the difficulty in identifying polyolefins that achieve fire safety requirements for plenum applications. The '503 patent discloses that, for plenum applications, the core should be formed from a solid low dielectric constant fluoropolymer, e.g., ethylene chlortrifluoroethylene (E-CTFE) or fluorinated ethylene propylene (FEP), a foamed fluoropolymer, e.g., foamed FEP, or polyvinyl chloride (PVC) in either solid, low dielectric constant form or foamed. The '503 patent observes that solid or foamed flame retardant polyolefin or similar materials are suitable for non-plenum applications.

While United States Provisional Patent Application Ser. No. 60/603,588 teaches a communication cable comprising a polyolefin-based separator, which cable passes the requirements of NFPA-262, it fails to specify how to select a polyolefin-based separator exhibiting excellent aging electrical properties. Moreover, none of the previously described references teaches how to achieve the desired fire retardant performance, the initial electrical properties, and the aged electrical properties.

There is a need for a polyolefin-based composition that readily meets the electrical and flame retardant requirements of plenum cables as well as maintains the desired initial and aged electrical properties. In particular, these compositions would provide substantial cost savings in replacing high cost FEP in insulation, tape, and separator applications.

### SUMMARY OF THE INVENTION

The present invention is a plenum cable component with excellent fire retardant and aging properties. The plenum cable component is prepared from a polyolefin-based composition. In the described embodiment, the polyolefin-based composition contains an olefinic polymer and a surface treated metal hydroxide. Depending upon the surface treatment, the composition may comprise other components.

The present invention is also a method for selecting a composition for preparing the plenum cable component as a separator and a method for preparing a communications cable therefrom.

### DESCRIPTION OF THE INVENTION

“Polymer,” as used herein, means a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, although it is often used interchangeably with “interpolymer” to refer to polymers made from three or more different types of monomers or comonomers), terpolymers (which usually refers to polymers prepared from three different types of monomers or comonomers), tetrapolymers (which usually refers to polymers prepared from four different types of monomers or comonomers), and the like. The terms “monomer” or “comonomer” are used interchangeably, and they refer to any compound with a polymerizable moiety which is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂.

The present invention is a plenum cable component with excellent fire retardant and aging properties. The plenum cable component is prepared from a polyolefin-based composition. The plenum cable component can be a separator, an insulation layer, a component in a multilayer insulation, a tape wrap, or a cable jacket.

A test specimen prepared from the polyolefin-based composition has a non-aged dissipation factor less than or equal to about 0.006 and an aged dissipation factor less than about 0.009. The dissipation factors are measured at 1.0 MHz. The aging conditions included subjecting the test specimen to a temperature of 90 degrees Fahrenheit and a relative humidity of 90 percent for two weeks.

Preferably, the non-aged dissipation factor and the aged dissipation factor are less than about 0.003.

Preferably, the test specimen would also exhibit a non-aged dielectric constant less than or equal to about 3.3, measured at 1.0 MHz.

Preferably and in addition to the non-aged dissipation factor being less than or equal to about 0.006, the aged dissipation factor should be less than or equal to about 150 percent of the non-aged dissipation factor. For example, when the non-aged dissipation factor is 0.004, the aged dissipation factor should be less than or equal to about 0.006.

In a first embodiment, the polyolefin-based composition comprises an olefinic polymer and a metal hydroxide being surface treated with a phosphorous-based composition.

As used herein, “olefinic polymer” is defined as any polymer containing at least one olefin monomer. Examples of suitable olefinic polymers are ethylene polymers, blends of ethylene polymers, propylene polymers, blends of propylene polymers, and blends of ethylene and propylene polymers. Preferably, the olefinic polymer is substantially halogen-free. Also, preferably, the olefinic polymer is nonpolar.

Ethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1 -butene, 1-hexene, 4-methyl-1-pentene, and 1-octene. The polyethylene can also be a copolymer of ethylene and an unsaturated ester such as a vinyl ester (for example, vinyl acetate or an acrylic or methacrylic acid ester), a copolymer of ethylene and an unsaturated acid such as acrylic acid, or a copolymer of ethylene and a vinyl silane (for example, vinyltrimethoxysilane and vinyltriethoxysilane).

The polyethylene can be homogeneous or heterogeneous. The homogeneous polyethylenes usually have a polydispersity (Mw/Mn) in the range of 1.5 to 3.5 and an essentially uniform comonomer distribution. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.960 gram per cubic centimeter, and preferably have a density in the range of 0.870 to 0.955 gram per cubic centimeter. They also can have a melt index in the range of 0. 1 to 50 grams per 10 minutes. If the polyethylene is a homopolymer, its melt index is preferably in the range of 0.3 to 3 grams per 10 minutes. Melt index is determined under ASTM D-1238, Condition E and measured at 190 degree C. and 2160 grams.

Low- or high-pressure processes can produce the polyethylenes. They can be produced in gas phase processes or in liquid phase processes (that is, solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degree C. In the stirred autoclave, the pressure is in the range of 10,000 to 30,000 psi and the temperature is in the range of 175 to 250 degree C.

Polymers comprised of ethylene and unsaturated esters or acids are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the polymer attributed to the ester comonomer can be in the range of 1 to 50 percent by weight based on the weight of the copolymer. Examples of the acrylates and- methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. Examples of the unsaturated acids include acrylic acids and maleic acids.

The melt index of the ethylene/unsaturated ester polymers or ethylene/unsaturated acid polymers can be in the range of 0.5 to 50 grams per 10 minutes, and is preferably in the range of 1 to 20 grams per 10 minutes.

Polymers of ethylene and vinyl silanes may also be used. Examples of suitable silanes are vinyltrimethoxysilane and vinyltriethoxysilane. Such polymers are typically made using a high-pressure process. Use of such ethylene vinylsilane polymers is desirable when a moisture crosslinkable composition is desired. Optionally, a moisture crosslinkable composition can be obtained by using a polyethylene grafted with a vinylsilane in the presence of a free radical initiator. When a silane-containing polyethylene is used, it may also be desirable to include a crosslinking catalyst in the formulation (such as dibutyltindilaurate or dodecylbenzenesulfonic acid) or another Lewis or Bronsted acid or base catalyst.

The VLDPE or ULDPE can be a polymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the polymer and is preferably in the range of 15 to 40 percent by weight.

A third comonomer can be included, for example, another alpha-olefin or a diene such as ethylidene norbornene, butadiene, 1,4-bexadiene, or a dicyclopentadiene. Ethylene/propylene polymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the polymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a polymer of ethylene and one or more alpha-olefins having 3 to 12 carbon atoms, and preferably 3 to 8 carbon atoms. The melt index can be in the range of 0.5 to 20 grams per 10 minutes, and is preferably in the range of 0.7 to 8 grams per 10 minutes.

Any polypropylene may be used in these compositions. Examples include homopolymers of propylene, polymers of propylene and other olefins, and terpolymers of propylene, ethylene, and dienes (for example, norbornadiene and decadiene). Additionally, the polypropylenes may be dispersed or blended with other polymers such as EPR or EPDM. Examples of polypropylenes are described in POLYPROPYLENE HANDBOOK: POLYMERIZATION, CHARACTERIZATION, PROPERTIES, PROCESSING, APPLICATIONS 3-14, 113-176 (E. Moore, Jr. ed., 1996).

Suitable polypropylenes may be components of TPEs, TPOs and TPVs. Those polypropylene-containing TPEs, TPOs, and TPVs can be used in this application.

Optionally, the olefinic polymer can have maleic anhydride grafts or be prepared by copolymerization with maleic anhydride. The grafted or copolymerized olefinic polymers may be prepared by any conventional method. As used herein, the maleic anhydride grafts are defined to also include the copolymerized olefinic polymers.

The maleic anhydride compounds are known in the relevant arts as having their olefin unsaturation sites conjugated to the acid groups. Fumaric acid, an isomer of maleic acid which is also conjugated, gives off water and rearranges to form maleic anhydride when heated, and thus is operable in the present invention. Grafting may be effected in the presence of oxygen, air, hydroperoxides, or other free radical initiators, or in the essential absence of these materials when the mixture of monomer and polymer is maintained under high shear and heat conditions. A convenient method for producing the graft polymer is extrusion machinery, although Brabender mixers or Banbury mixers, roll mills and the like may also be used for forming the graft polymer. It is preferred to employ a twin-screw devolatilizing extruder (such as a Werner-Pfleiderer twin-screw extruder) wherein maleic anhydride is mixed and reacted with the olefinic polymer at molten temperatures to produce and extrude the grafted polymer.

The anhydride groups of the grafted polymer generally comprise from about 0.001 to about 10 weight percent, preferably from about 0.01 to about 5 weight percent, and especially from 0.1 to about 1 weight percent of the grafted polymer. to The grafted polymer is characterized by the presence of pendant anhydride groups along the polymer chain.

Suitable metal hydroxides are surface treated with a phosphorous-based composition, including aluminum trihydroxide (also known as ATH or aluminum trihydrate) and magnesium hydroxide (also known as magnesium dihydroxide). Other metal hydroxides are known to persons of ordinary skill in the art. The use of those metal hydroxides is considered within the scope of the present invention. Preferably, the metal hydroxide is a magnesium hydroxide.

The average particle size of the metal hydroxide may range from less than 0.1 micrometers to 50 micrometers. In some cases, it may be desirable to use a metal 20 hydroxide having a nanoscale particle size. The metal hydroxide may be naturally occurring or synthetic.

The polyolefin-based composition may contain other flame-retardant additives. Other suitable non-halogenated flame, retardant additives include red phosphorus, silica, alumina, titanium oxides, carbon nanotubes, talc, clay, organo-modified clay, silicone polymer, calcium carbonate, zinc borate, antimony trioxide, wollastonite, mica, hindered amine stabilizers, ammonium octamolybdate, melamine octamolybdate, frits, hollow glass microspheres, intumescent compounds, expandable graphite, ethylene diamine phosphate, melamine phosphate, melamine pyrophosphate, melamine polyphosphate, and ammonium polyphosphate. Suitable halogenated flame retardant additives include decabromodiphenyl oxide, decabromodiphenyl ethane, ethylene-bis (tetrabromdphthalimide), and dechlorane plus.

In addition, the polyolefin-based composition may contain a nanoclay. When present, the nanoclay has at least one dimension in the 0.9 to 200 nanometer-size range, more preferably at least one dimension in the 0.9 to 150 nanometers, even more preferably 0.9 to 100 nanometers, and most preferably 0.9 to 30 nanometers.

When present, the nanoclays are preferably layered, including nanoclays such as montmorillonite, magadiite, fluorinated synthetic mica, saponite, fluorhectorite, laponite, sepiolite, attapulgite, hectorite, beidellite, vermiculite, kaolinite, nontronite, volkonskoite, stevensite, pyrosite, sauconite, and kenyaite. The layered nanoclays may be naturally occurring or synthetic.

Some of the cations (for example, sodium ions) of the nanoclay can be exchanged with an organic cation, by treating the nanoclay with an organic cation-containing compound. Alternatively, the cation can include or be replaced with a hydrogen ion (proton). Preferred exchange cations are imidazolium, phosphonium, ammonium, alkyl ammonium, and polyalkyl ammonium. An example of a suitable ammonium compound is dimethyl, di(hydrogenated tallow) ammonium. The cationic coating will typically be present in 15 to 50% by weight, based on the total weight of layered nanoclay plus cationic coating. Another ammonium coating is octadecyl ammonium.

The composition may contain a coupling agent to improve the compatibility between the olefinic polymer and the nanoclay. Examples of coupling agents include silanes, titanates, zirconates, and various polymers grafted with maleic anhydride. Other coupling technology would be readily apparent to persons of ordinary skill in the art and is considered within the scope of this invention.

In addition, the polyolefin-based composition may contain other additives such as antioxidants, stabilizers, blowing agents, carbon black, pigments, processing aids, peroxides, cure boosters, and surface active agents to treat fillers may be present. Furthermore, the polyolefin-based composition may be thermoplastic or crosslinked.

In an alternate embodiment, the polyolefin-based composition comprises an olefinic polymer having a maleic anhydride graft and a metal hydroxide being surface treated. The suitable olefinic polymers include grafted version of the polymers described in reference to the first embodiment.

Suitable metal hydroxides are surface treated and include aluminum trihydroxide (also known as ATH or aluminum trihydrate) and magnesium hydroxide (also known as magnesium dihydroxide). Other metal hydroxides are known to persons of ordinary skill in the art. The use of those metal hydroxides is considered within the scope of the present invention. Preferably, the metal hydroxide is a magnesium hydroxide.

The surface of the metal hydroxide may be treated with one or more materials, including, but not limited to, silanes, titanates, zirconates, carboxylic acids, and maleic anhydride-grafted polymers. Suitable treatments include those disclosed in U.S. Pat. No. 6,500,882. Preferably, the treatment is silane-based or carboxylic acid-based.

The average particle size may range from less than 0.1 micrometers to 50 micrometers. In some cases, it may be desirable to use a metal hydroxide having a nano-scale particle size. The metal hydroxide may be naturally occurring or synthetic.

The polyolefin-based composition may contain other flame-retardant additives. Other suitable non-halogenated flame retardant additives include red phosphorus, silica, alumina, titanium oxides, carbon nanotubes, talc, clay, organo-modified clay, silicone polymer, calcium carbonate, zinc borate, antimony trioxide, wollastonite, mica, hindered amine stabilizers, ammonium octamolybdate, melamine octamolybdate, frits, hollow glass microspheres, intumescent compounds, expandable graphite, ethylene diamine phosphate, melamine phosphate, melamine pyrophosphate, melamine polyphosphate, and ammonium polyphosphate. Suitable halogenated flame retardant additives include decabromodiphenyl oxide, decabromodiphenyl ethane, ethylene-bis (tetrabromophthalimide), and dechlorane plus.

Preferably, the polyolefin-based composition of the present embodiment is substantially-free of nanoclays. More preferably, there are no nanoclays present in the composition.

In yet another embodiment, the polyolefin-based composition comprises an olefinic polymer, an olefinic polymer having a maleic anhydride graft, and a metal hydroxide being surface treated. The previously-described materials can be used as the olefinic polymer, the olefinic polymer having a maleic anhydride graft, and the surface-treated metal hydroxide.

In yet another embodiment, the polyolefin-based composition comprises an olefinic polymer and a metal hydroxide being surface treated. The previously-described materials can be used as the olefinic polymer.

Suitable metal hydroxides are surface treated and include aluminum trihydroxide (also known as ATH or aluminum trihydrate) and magnesium hydroxide (also known as magnesium dihydroxide). Other metal hydroxides are known to persons of ordinary skill in the art. The use of those metal hydroxides is considered within the scope of the present invention. Preferably, the metal hydroxide is a magnesium hydroxide.

The surface of the metal hydroxide may be treated with one or more materials, including, but not limited to, silanes, titanates, zirconates, carboxylic acids, phosphorous-based compositions, and maleic anhydride-grafted polymers. Suitable treatments include those disclosed in U.S. Pat. No; 6,500,882. Preferably, the treatment is phosphorous-based.

In yet another embodiment, the present invention is a process for selecting a polyolefin-based composition for use in a plenum cable. The process comprises the steps of (a) selecting an olefinic polymer, (b) selecting a surface-treated metal hydroxide, (c) mixing the olefinic polymer and the surface-treated metal hydroxide to form a polyolefin-based composition, (d) measuring the non-aged dissipation factor and aged dissipation factor at 1.0 MHz on a test specimen prepared from the polyolefin-based composition, (e) preparing a plenum cable using the polyolefin-based composition as a flame retardant component provided the test specimen having a non-aged dissipation factor less than or equal to about 0.006 and an aged dissipation factor less than about 0.009, and (f) measuring the flame retardant performance of the plenum cable according to UL-910, FT6, or NFPA-262.

The previously-described materials can be used as the olefinic polymer.

Suitable metal hydroxides are surface treated and include aluminum trihydroxide (also known as ATH or aluminum trihydrate) and magnesium hydroxide (also known as magnesium dihydroxide). Other metal hydroxides are known to persons of ordinary skill in the art. The use of those metal hydroxides is considered within the scope of the present invention. Preferably, the metal hydroxide is a magnesium hydroxide.

The surface of the metal hydroxide may be treated with one or more materials, including, but not limited to, silanes, titanates, zirconates, carboxylic acids, phosphorous-based compositions, and maleic anhydride-grafted polymers. Suitable treatments include those disclosed in U.S. Pat. No. 6,500,882. Preferably, the treatment is phosphorous-based.

In another embodiment, the present invention is an invented communication cable, which comprises a plurality of twisted pair conductors, a separator, and a communication cable jacket enclosing the plurality of twisted pair conductors and the separator. The communication cable passes the requirements of NFPA-262.

Each of the twisted pair conductors include a pair of individually insulated metal conductors that are twisted together to form one of the plurality of twisted pair conductors. The metal conductor is typically a solid fine gauge copper wire although other conductors such as stranded copper or other metals may be used as appropriate to meet the electronic transmission and other application requirements. A uniform thickness of insulation material is applied over this conductor with the thickness of the insulating material typically less than 20 mils and preferably less than about 10 mils.

The separator is a plenum cable component prepared from any of the previously-described polyolefin-based compositions. Physically, the separator is constructed such that it has a plurality of outwardly protruding projections angularly spaced about a core. The plurality of outwardly protruding projections protrude radially from the core and define regions between adjacent ones of the outwardly protruding projections within each of which one of the plurality of twisted pair conductors is contained.

The jacket is made of a flexible polymer material and is preferably formed by melt extrusion. Preferable polymers include polyvinylchloride, fluoropolymers, and flame retardant polyolefins. Preferably, the jacket is extruded to a thickness of between 15 and 25 mils to allow the jacket to be easily stripped from the twisted pairs of insulated conductors.

In an alternate embodiment, the present invention is a method for preparing a NFPA-262 communication cable comprising the steps of (a) selecting a polyolefin-based composition, (b) preparing a plurality of twisted pair conductors, (c) preparing a separator having a plurality of outwardly protruding projections from the polyolefin-based composition, (d) separating the plurality of twisted pair conductors by the plurality of outwardly protruding projections of the separator, and (e) enclosing with a communication cable jacket the plurality of twisted pair conductors separated by the plurality of outwardly protruding projections of the separator.

### EXAMPLES

The following non-limiting examples illustrate the invention.

### Comparative Examples 1-4 and Examples 5 and 13

Thirteen polyolefin-based compositions were prepared for determination of initial and aged electrical properties. The components used in preparing the compositions and their amounts are shown in Table I.

Dissipation factors (DF) were measured according to ASTM D150 at 1.0 MHz. The initial electrical properties were determined after the test specimens were dried at 60 degrees Celsius and under a vacuum greater than 1 inch of mercury. When aged, the test specimens were subjected to a temperature of 90 degrees Fahrenheit and a relative humidity of 90 percent for two weeks to simulate long term exposure to ambient humidity. The electrical properties are reported in Table I.

Affinity₁₉₈ EG-8200 polyethylene (PE1) is commercially available from The Dow Chemical Company with a melt index of 5.0 grams/10 minutes, a density 0.87 grams/ cubic centimeter, and a polydispersity index of less than 3. Amplify™ GR-208 (PE2) is a very low density ethylene/butene copolymer, having a 0.3 weight percent maleic anhydride graft, a density of 0.899 grams/cubic-centimeters, and a melt index of 3.3 grams/10 minutes, which is commercially available from The Dow Chemical Company.

Both Kisuma 5B-1G magnesium hydroxide (MGH1) and Kisuma 5J magnesium hydroxide (MGH3) are available from Kyowa Chemicals. Kisuma 5B-1G magnesium hydroxide has a surface area of 6.1 m²/g (as determined by the BET method) and an average particle size of 0.8 microns (800 nanometers), and contains an oleic acid surface treatment. Kisuma 5J magnesium hydroxide has a surface area of 3 m²/g (as determined by the BET method) and an average particle size of 0.8 microns (800 nanometers), and contains an alcohol phosphate ester surface treatment. Magnifin H10A magnesium hydroxide (MGH2) is available from Albemarle Corporation, has a surface area of about 10 m²/g (as determined by the BET method) and an average particle size of 0.8 microns (800 nanometers), and contains a silane-based surface treatment.

Nanoblend 3100 nanoclay masterbatch (Nano1) is a 40% dispersion of nanoclay in ethylene-methyl acrylate polymer and Nanoblend 2001 nanoclay masterbatch (Nano2) is a 40% dispersion of nanoclay in low density polyethylene. Both nanoclay masterbatches are available from Polyone Corporation.

Minstron ZSC grade talc has an average particle size of 1.5 microns and a surface area of about 16 m/g (as determined by the BET method), contains a zinc stearate surface treatment, and is available from Luzenac Corporation. MB 50-002™ silicone polymer masterbatch (SilMB) is a 50:50 ultra high molecular weight polydimethylsiloxane/low density polyethylene masterbatch available from Dow Corning Corporation. Irganox 1010 tetrakismethylene (3,5-di-t-butyl-4-hydroxylhydrocinnamate) methane (AO) is hindered phenolic antioxidant, available from Ciba Specialty Chemicals Inc.

TABLE I

| | | | | | | | | | | | | |
|---|---|---|---|---|---|---|---|---|---|---|---|---|
| Comp.1 | Comp. 2 | Comp. 3 | Comp. 4 | Ex. 5 | Ex. 6 | Ex. 7 | Ex. 8 | Ex. 9 | Ex. 10 | Ex. 11 | Ex. 12 | Ex. 13 |

Components by weight percent

| | | | | | | | | | | | | | |
|---|---|---|---|---|---|---|---|---|---|---|---|---|---|
| PE1 | 13.30 | 13.30 | 26.80 | 26.80 | 20.80 | 16.80 | 17.05 | 20.80 | 26.80 | 13.30 | 19.30 | 20.80 | 20.80 |
| PE2 | 6.00 | 6.00 | | | 6.00 | 6.00 | 6.00 | 6.00 | | 6.00 | | 6.00 | 6.00 |
| MGH1 | 65.00 | 65.00 | 70.00 | | | | | 70.00 | | | | | |
| MGH2 | | | | 70.00 | | | | | | | | | 70.00 |
| MGH3 | | | | | 70.00 | 74.00 | 67.50 | | 70.00 | 65.00 | 65.00 | 67.00 | |
| Nano1 | 12.50 | | | | | | | | | | | | |
| Nano2 | | 12.50 | | | | | 6.25 | | | 12.50 | 12.50 | | |
| Talc | | | | | | | | | | | | 3.00 | |
| SilMB | 3.00 | 3.00 | 3.00 | 3.00 | 3.00 | 3.00 | 3.00 | 3.00 | 3.00 | 3.00 | 3.00 | 3.00 | 3.00 |
| AO | 0.20 | 0.20 | 0.20 | 0.20 | 0.20 | 0.20 | 0.20 | 0.20 | 0.20 | 0.20 | 0.20 | 0.20 | 0.20 |

Electrical Propertes

| | | | | | | | | | | | | | |
|---|---|---|---|---|---|---|---|---|---|---|---|---|---|
| Initial DF | 0.0031 | 0.0014 | 0.0010 | 0.0009 | 0.0007 | 0.0008 | 0.0010 | 0.0009 | 0.0007 | 0.0014 | 0.0013 | 0.0009 | 0.0009 |
| Aged DF | 0.014 | 0.011 | 0.016 | 0.035 | 0.0012 | 0.0012 | 0.0023 | 0.0053 | 0.0013 | 0.0033 | 0.0037 | 0.0018 | 0.0015 |

What is claimed is:

1. A plenum cable component prepared from a polyolefin-based composition comprising:
a. an olefinic polymer and
b. a metal hydroxide being surface treated with a phosphorous-based composition,
wherein a test specimen prepared from the polyolefin-based composition having a non-aged dissipation factor less than or equal to about 0.006 and an aged dissipation factor less than about 0.009, wherein the dissipation factors being measured at 1.0 MHz, and wherein the aged dissipation factor being measured on an aged test specimen subjected, for two weeks, to a temperature of 90 degrees Fahrenheit and a relative humidity of 90 percent.

2. The plenum cable component prepared according to claim 1 wherein the olefinic polymer having a maleic anhydride graft

3. The plenum cable component prepared according to claim 1 further comprising a nanoclay.

4. A plenum cable component prepared from a polyolefin-based composition comprising:
a. an olefinic polymer having a maleic anhydride graft and
b. a metal hydroxide being surface treated,
wherein a test specimen prepared from the polyolefin-based composition having a, non-aged dissipation factor less than or equal to about 0.006 and an aged dissipation factor less than about 0.009,
wherein the dissipation factors being measured at 1.0 MHz, and
wherein the aged dissipation factor being measured on an aged test specimen subjected, for two weeks, to a temperature of 90 degrees Fahrenheit and a relative humidity of 90 percent.

5. The plenum cable component prepared according to claim 4 wherein the polyolefin-based composition being substantially-free of nanoclays.

6. The plenum cable component prepared according to claim 4 wherein the polyolefin-based composition being free of nanoclays.

7. The plenum cable component prepared according to claim 4 wherein the surface treatment being selected from the group consisting of silane-based and oleic acid-based treating agents.

8. A plenum cable component prepared from a polyolefin-based composition comprising:
a. an olefinic polymer,
b. an olefinic polymer having a maleic anhydride graft, and
c. a metal hydroxide being surface treated,
wherein a test specimen prepared from the polyolefin-based composition having a non-aged dissipation factor less than or equal to about 0.006 and an aged dissipation factor less than about 0.009,
wherein the dissipation factors being measured at 1.0 MHz, and
wherein the aged dissipation factor being measured on an aged test specimen subjected, for two weeks, to a temperature of 90 degrees Fahrenheit and a relative humidity of 90 percent.

9. The plenum cable component prepared according to claim 1, 4, or 8 wherein the non-aged dissipation factor and the aged dissipation factor being less than about 0.003.

10. The plenum cable component prepared according to claim 1, 4, or 8 wherein the aged dissipation factor ≦(1.50×the non-aged dissipation factor).

11. The plenum cable component prepared according to claim 1, 4, or 8 wherein the olefinic polymer of the polyolefin-based composition being substantially halogen free.

12. The plenum cable, component prepared according to claim 1, 4, or 8 wherein the polyolefin-based composition further comprises a silicon polymer.

13. A communication cable comprising:
a. a plurality of twisted pair conductors, each of the twisted pair conductors including a pair of individually insulated metal conductors that are twisted together to form one of the plurality of twisted pair conductors;
b. a separator
(i) being prepared according to any of claims 1-12 and
(ii) having a plurality of outwardly protruding projections angularly spaced about a core, the plurality of outwardly protruding projections protruding radially from the core and defining regions between adjacent ones of the outwardly protruding projections within each of which one of the plurality of twisted pair conductors is contained; and
c. a communication cable jacket enclosing the plurality of twisted pair conductors separated by the plurality of outwardly protruding projections of the separator,
wherein the communication cable passes the requirements of NFPA-262;
